(19) United States
(12) Patent Application Publication
(10) Pub. No.: US 2017/0149373 A1
(43) Pub. Date: May 25, 2017

(54) METHODS AND SYSTEMS FOR DYNAMICALLY CONTROLLING A PHOTOVOLTAIC POWER PLANT

(71) Applicant: SunEdison, Inc., Maryland Heights, MO (US)

(72) Inventors: Rasool Aghatehrani, Redwood City, CA (US); Martin Lee Smirl, SR., Carmichael, CA (US); Abhijeet Dinkar Sathe, Fremont, CA (US)

(21) Appl. No.: 14/949,296

(22) Filed: Nov. 23, 2015

(51) Int. Cl. H02S 10/00; G05B 15/02; H02M 7/44

(52) U.S. Cl. CPC H02S 10/00; H02M 7/44; G05B 15/02

(57) ABSTRACT

A computer-implemented method for dynamically controlling a plurality of photovoltaic (PV) inverters is provided. The method is implemented by a dynamic photovoltaic (DP) controller in communication with a user interface. The method includes receiving, from an electrical meter, an electrical value of a plurality of electrical values associated with an inverter of the plurality of PV inverters, where the electrical meter is associated with point of interconnection between the plurality of inverters and an electrical grid, calculating, an electrical metric based on the electrical value, generating, a command signal for the inverter based on the calculated electrical metric, transmitting the command signal to the inverter, the command signal configured to change an output power level of the inverter, and causing the inverter to change the power level via the command signal.

### FIELD

The field of the disclosure relates generally to controlling photovoltaic (PV) power plant systems. More particularly, this disclosure relates to methods and systems for dynamically controlling an operation of photovoltaic power plant components.

### BACKGROUND

In PV power plants, power flow (e.g., both active and reactive power) is controlled by PV inverters (also known as “inverters”). An inverter is a device designed to convert direct current (DC) into alternating current (AC) (e.g., that which is consumed by an electrical grid). For example, an inverter may convert DC power generated by a PV solar power module into AC power and transfer the AC power to an electrical grid for consumption. Based on the requirements of the electrical grid, PV power plants may need to perform specific control functions to maintain certain electrical parameters at a point of interconnection (POI) between the PV power plant and the grid. Inverters are connected to the electrical grid via a point of interconnection, using a number of cables, transformers, or other connective equipment.

Components of connective equipment such as cables, transformers cause power losses. In a PV plant with multiple PV inverters, the inverters operate independently without access to measurements (including measurements of power loss) from the point of connection to the grid. In such a configuration, efficiently compensating for losses is difficult or impossible since each isolated inverter is unaware of the specific power losses attributable to its specific power flow stream. Moreover, because these inverters operate independently, none of these inverters are aware of the power losses occurring at any of the other inverters.

For large PV plants, PV modules connected to different inverters may generate different levels of power for a plant having an overall power level. Because of the independent operation of the inverters, the potential for inverters receiving higher DC power levels to fill the gap created by the inverters with lower DC power levels in achieving the overall power level is neglected. Additionally, if an inverter loses efficiency or fails, the PV plant is unable to compensate such a loss efficiently.

Similarly, PV plants need to control voltage levels, which are dependent on PV plant specifications as well as grid characteristics. Without access to the voltage measurements from the POI to the grid, performing voltage regulation at the inverters may be cumbersome or unworkable.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

In one aspect, a computer-implemented method for dynamically controlling a plurality of photovoltaic (PV) inverters is provided. The method is implemented by a dynamic photovoltaic (DP) controller in communication with a user interface. The method includes receiving from an electrical meter, by the DP controller, at least one electrical value of a plurality of electrical values associated with at least one inverter of the plurality of PV inverters, where the electrical meter is associated with at least one point of interconnection between the plurality of inverters and an electrical grid, calculating, by the DP controller, an electrical metric based on the at least one electrical value, generating, by the DP controller, a command signal for the at least one inverter based on the calculated electrical metric, transmitting the command signal to the at least one inverter, the command signal configured to change an output power level of the at least one inverter, and causing the at least one inverter to change the power level via the command signal.

In another aspect, a dynamic PV power plant (DP) controller is provided, the DP controller includes a processor and a memory device. The DP controller is in communication with a supervisory control and data acquisition (SCADA) user interface. The DP controller is configured to: receive, from an electrical meter, at least one electrical value of a plurality of electrical values associated with at least one inverter of the plurality of PV inverters, where the electrical meter is associated with at least one point of interconnection between the plurality of inverters and an electrical grid, calculate an electrical metric based on the at least one electrical value, generate a command signal for the at least one inverter based on the calculated electrical metric, transmit the command signal to the at least one inverter, the command signal configured to change an output power level of the at least one inverter, and cause the at least one inverter to change the power level via the command signal.

In yet another aspect, one or more non-transitory computer-readable storage media having computer-executable instructions embodied thereon for dynamically controlling a plurality of photovoltaic (PV) inverters are provided. When executed by a dynamic photovoltaic power plant (DP) controller, the computer-executable instructions cause the DP controller to receive, from an electrical meter, at least one electrical value of a plurality of electrical values associated with at least one inverter of the plurality of PV inverters, where the electrical meter is associated with at least one point of interconnection between the plurality of inverters and an electrical grid, calculate an electrical metric based on the at least one electrical value, generate a command signal for the at least one inverter based on the calculated electrical metric, transmit the command signal to the at least one inverter, the command signal configured to change an output power level of the at least one inverter, and cause the at least one inverter to change the power level via the command signal.

### BRIEF DESCRIPTION OF THE DRAWINGS

FIG. 1 shows a photovoltaic power plant system with a dynamic photovoltaic controller (DPC) computer device operating in conjunction with other power plant components.

FIGS. 2 and 3 illustrate an example active power command flow used by the DPC computer device to control the operation of individual PV inverters.

FIGS. 4 and 5 illustrate an example load following command flow used by the DPC computer device to control the operation of individual PV inverters.

FIG. 6 illustrates an example reactive power command flow used by the DPC computer device to control power factor in the operation of individual PV inverters.

FIG. 7 illustrates an example reactive power command flow used by the DPC computer device to control voltage in the operation of individual PV inverters.

FIG. 8 illustrates an example reactive power command flow used by the DPC computer device to control reactive power levels in the operation of individual PV inverters.

FIG. 9 illustrates an example flow showing the DPC computer device calculating an inverter power factor setpoint.

FIG. 10 illustrates an example method by which the DPC computer device controls the operation of individual inverters.

FIG. 11a shows an example graph of the DPC computer device limiting active power in accordance with inputs received from the PV power plant system shown in FIG. 1.

FIG. 11b shows an example graph of the DPC computer device limiting ramp rate in accordance with inputs received from the PV power plant system shown in FIG. 1.

FIG. 12a is an example reactive power graph showing the DPC computer device maintaining a constant reactive power level with respect to active power levels.

FIG. 12b is an example power factor graph showing the DPC computer device maintaining a constant power factor for each inverter.

FIG. 13 is an example voltage graph showing the DPC computer device providing inputs to an inverter to adjust reactive power.

Like reference symbols in the various drawings indicate like elements.

### DETAILED DESCRIPTION

Computer systems, such as a dynamic PV power plant control computer system, may include a processor and a memory. However, any processor in a computer device referred to herein may also refer to one or more processors wherein the processor may be in one computing device or a plurality of computing devices acting in parallel. Additionally, any memory in a computer device referred to may also refer to one or more memories, wherein the memories may be in one computing device or a plurality of computing devices acting in parallel.

In one embodiment, the dynamic PV power plant controller computer system includes a dynamic photovoltaic controller (DPC) computer device programmed to perform control functions upon PV inverters using specifically configured computer-executable instructions. The DPC computer device is configured to perform at least the following control functions: dynamic active power control, output ramp rate control, dynamic reactive power control, dynamic power factor control and dynamic voltage regulation.

In one embodiment, the DPC computer device is connected to an electrical grid via a point of interconnection (POI). The grid receives electrical power from one or more PV inverters and supplies that power to consumers, such as homes, businesses, factories, or the like. There will be one or more meter devices at the POI configured to measure electrical values such as voltage, current, power, resistance, or the like. The DPC computer device is configured to use measurements from the POI that are received from the electrical grid (e.g., how much power is being used by the grid). The DPC computer device is also connected to the PV inverters. Based on electrical values received from the meter(s) at the POI, the DPC computer device sends individualized commands to each inverter. The commands are configured to cause the inverters to increase or decrease power output, thereby compensating losses corresponding to power transformers, cables and local loads by using the extra capacity of the inverters.

Deficiency in the operation of one or more of the inverters is measured by the variables provided by the meter at the point of connection to the grid. Therefore, the DPC computer device utilizes available capacity of the rest of the inverters to optimize the operation of the system. The DPC computer device monitors the operation of the inverters and creates individual commands for each inverter to optimize the utilization of each inverter. A nonlinear control schema allows the DPC computer device to adjust the response to variation in the electrical values and therefore further optimize the use of available inverter capacity.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.” The term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above are only examples, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a server computer. In a further embodiment, the system is run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, “SCADA” refers to a supervisory control and data acquisition system. In one embodiment, the DPC computer device functions as a SCADA device, (i.e., receiving data from external sources such as meters at the POI and generating control commands for transmission to inverters).

As used herein, “deadband” or “deadband module” refers to a computer module designed to maintain an electrical value (such as voltage) within a predetermined limit.

As used herein, “gain” or “gain module” refers to a computer module designed to increase or decrease the amplitude of an incoming electrical value (such as voltage).

As used herein, a limited proportional controller refers to a computer module configured to generate a proportional gain Kₚ for an electrical value within predetermined specific limits.

As used herein, a limited integral controller refers to a computer module configured to generate an integral gain Kᵢ for an electrical value within predetermined specific limits.

As used herein, a “sample and hold module” refers to a computer module designed to sample an incoming voltage and hold (e.g., lock or maintain) its value at a constant level for a specified minimum period of time.

As used herein, “global active power set point” or “global maximum active power set point” refers to a value for an electrical measurement (e.g., voltage, power, current, etc.) that is the value required by the electrical grid, based on load or demand. For example, the grid may require 20 megawatts (MW) of power to be generated continuously during the hours of 7 AM to 9 AM. As such, the combined output of all inverters joined to the grid via the POI must not exceed 20 MW.

As used herein, “inverter active power setpoint” or “inverter maximum active power setpoint” refers to a value for an electrical measurement (e.g., voltage, power, current, etc.) that is the value that an individual PV inverter must meet or generate. For example, where global active power setpoint is 20 MW and there are ten inverters, each inverter may be required to output 2 MW of power, in which case 2 MW will be the inverter's active power setpoint. Accordingly, the DPC computer device is configured to provide 2 MW as the inverter active power setpoint to the inverter to cause it to provide no more or less than the setpoint level of power.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The methods and systems described herein may be implemented using computer programming or engineering techniques including computer software, firmware, hardware, or any combination or subset thereof, wherein the technical effects may be achieved by performing at least one of the following steps: (a) receiving from an electrical meter, by the DP controller, at least one electrical value of a plurality of electrical values associated with at least one inverter of the plurality of PV inverters, where the electrical meter is associated with at least one point of interconnection between the plurality of inverters and an electrical grid, (b) calculating, by the DP controller, an electrical metric based on the at least one electrical value, (c) generating, by the DP controller, a command signal for the at least one inverter based on the calculated electrical metric, (d) transmitting the command signal to the at least one inverter, the command signal configured to change an output power level of the at least one inverter, and (e) causing the at least one inverter to change the power level via the command signal.

The resulting technical benefits achieved by this system include at least one of: (i) ability to remotely control individual inverters, thereby more accurately managing inverter power output and reducing overshoots or under-generation due to solar resource variations, system load changes, inverter technical limitations, or the like, (ii) centralized and computerized management of inverters, reducing the need for quality checks or monitoring of individual inverters, (iii) accurate monitoring and tracking of inverter operation, enabling statistical analysis of inverter performance, leading to a greater ability to manage inverters (e.g., maintenance or removal from service) over their service lives.

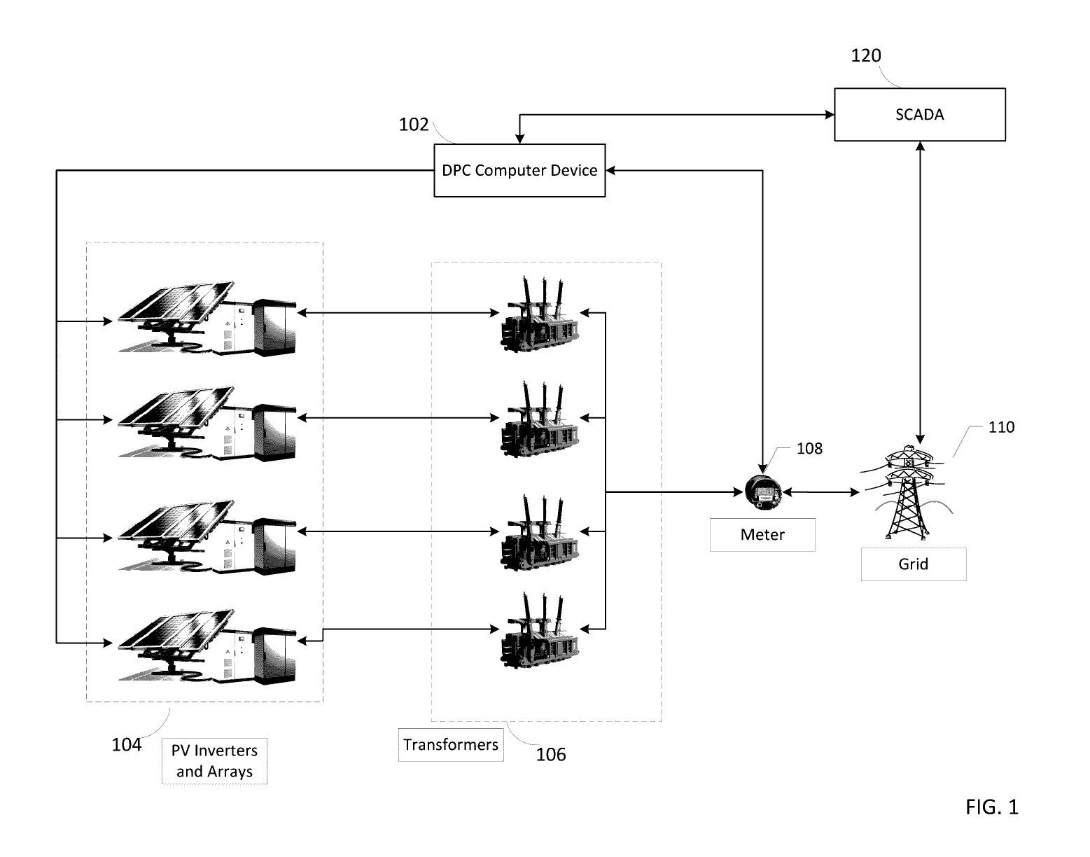

FIG. 1 shows a photovoltaic power plant system 100 with a DPC computer device 102 in operation. As shown, a plurality of PV inverters 104 are connected to a plurality of transformers 106 via electrical cables. In one embodiment, each inverter is in connection with a photovoltaic array that is configured to generate electrical power by converting solar radiation into electricity. The generated electricity is in the form of direct current (DC). Each inverter is configured to convert the DC electrical power into alternating current (AC) electrical power for use by an electrical grid. The converted AC electrical power is transmitted to transformers 106. Transformers 106 are configured to reduce or increase the voltage of the AC electrical power.

The AC electrical power (also referred to as output AC electrical power) is transmitted via transformers 106 to a grid 110. The output AC electrical power is measured using a meter 108. In one embodiment, meter 108 comprises multiple measuring devices that are configured to measure a variety of electrical values (e.g., voltage, current, resistance, power, power factor, reactive power, or the like). Meter 108 is configured to transmit its measurement of electrical values to dynamic PV controller (DPC) computer device 102 (also referred to herein as DPC 102). In one embodiment, DPC 102 is configured to control the operation of PV inverters 104 using the received electrical values. In addition, DPC computer device 102 also receives inputs from a supervisory control and data acquisition (SCADA) system 120. In one embodiment, SCADA 120 is configured to send inputs to DPC computer device 102 regarding grid status, weather patterns, and other remote operations commands that are used by the DPC computer device 102 to perform its inverter control functions. In one embodiment, DPC 102 is a separate computer device in communication with SCADA 120. In another embodiment, DPC 102 is a computer device that is part of SCADA 120.

In the example embodiment, DPC 102 is configured to control the generation of power to match the global active power setpoint mandated by, for example, a grid operator. When enough solar resources are available and the inverters and PV arrays have capacity to generate more than the global active power setpoint, DPC 102 is configured to decrease power generation by providing, for example, power output decrease command signals to each individual inverter. If the output power levels for system 100 are below the global active power setpoint, DPC 102 is configured to increase power generation at a predetermined rate (e.g., a constant rate or continuously decreasing or increasing rate) to prevent output power from overshooting the global active power setpoint.

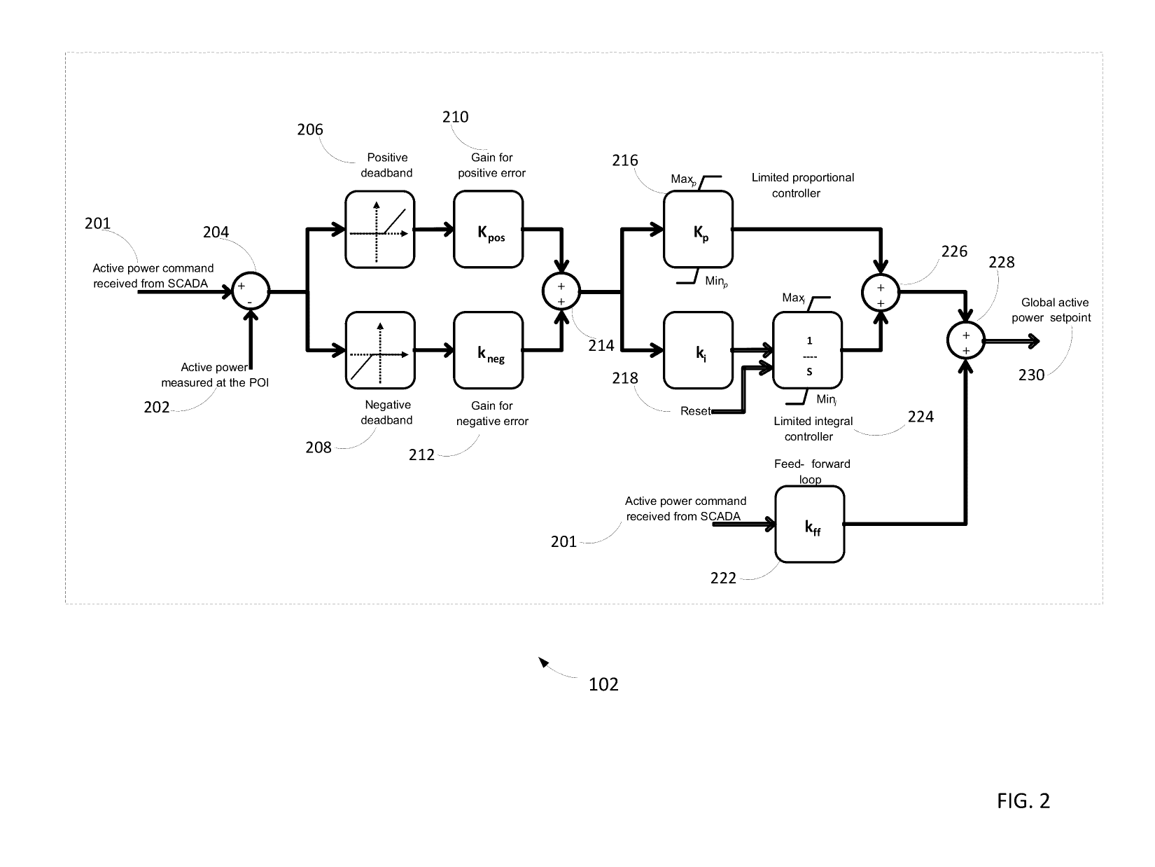

FIGS. 2 and 3 illustrate an example active power command flow used by the DPC computer device to control the operation of individual PV inverters. As shown in FIG. 2, DPC 102 receives an active power command 201, based on current demand, from SCADA 120. DPC 102 also receives an active power input 202 measured at the POI from the grid. In one embodiment, active power command 201 and active power input 202 both include a value for voltage. In other embodiments, the value may be for power, current, or the like. The voltage value received from active power input 202 is subtracted from voltage received from active power command 201. The voltage value is provided to at least one of a positive deadband function 206 and a negative deadband function 208. From positive deadband function 206, the voltage value is fed to a positive gain module 210.

From negative deadband function 208, the voltage value is fed to a negative gain module 212. Voltage values from positive gain module 210 and negative gain module 212 are summed 214 and fed to a limited proportional controller 216 and a limited integral controller 218. Limited proportional controller 216 determines a proportional gain Kₚ. Limited integral controller 224 determines an integral gain Kᵢ, and performs a Laplace transform of the integral gain Kᵢ. In one embodiment, a reset command 218 may also be applied at limited integral controller 224. The output voltage value from limited proportional controller 216 and limited integral controller 224 is summed at a first summer 226. Additionally, active power command 201 is also provided to a feedforward loop module 222, which feeds active power command 201 to a second summer 228. At second summer 228, the output summed voltage value from first summer 226 is added to the output voltage value from feedforward loop module 222. The final sum from second summer 228 is designated a global active power setpoint 230.

FIG. 3 illustrates an example flow of DPC 102 generating the individual inverter active power setpoint for a particular inverter using the global active power setpoint. DPC 102 receives the global active power setpoint 322 (similar to global active power setpoint 230 shown in FIG. 2), a manually entered value for the inverter active power setpoint 324, and enters both values into a selector module 302. Selector module 302 is configured to determine whether global active power setpoint 322 or manual inverter active power setpoint 324 is to be used for input to generate a setpoint command for the inverter, using a manual/auto selection decision setting 320. In one embodiment, an operator operating SCADA 120 may set selector module 302 to choose between global active power setpoint 322 and inverter active power setpoint 324. The operator also provides an acceptable ramp rate 330 (i.e., the acceptable rate of change of the output for the inverter (e.g., 2%/minute)). The power currently being generated by the inverter is input as active inverter power 332 into sample and hold module 306. Sample and hold module 306 also takes as input a time t for how long to “sample and hold” from a time 304.

Acceptable ramp rate 330 and output from sample and hold module 306 is summed at a summer 334. To perform the ramp rate calculation, active inverter power 332 is added to acceptable ramp rate 330 to calculate the maximum power the inverter can generate at the end of a ramp-rate period. In one embodiment, a ramp-rate period is defined as a time period during which the output power for an inverter is increased or decreased by a predetermined ramp rate (e.g., ramp up or ramp down). For example, if active inverter power 332 is currently 90% of maximum, acceptable ramp rate 330 is 2%, and the time t is one minute, the sample and hold module 306 will limit active inverter power 332 to 90%. The output of summer 334 will not exceed [90%+2%] during that one minute.

The sum from summer 334 and the selection of setpoint from selector module 302 is provided to a minimum selector module 310, configured to select the minimum value from two or more input values. Additionally, an inverter status analyzer 308 receives status data from the inverter. Output from inverter status analyzer 308 and minimum selector module 310 is provided to interrupt module 312. Interrupt module 312 is configured to interrupt command flow to the inverter based on status data received from status analyzer 308. For example, if status data indicates that the inverter is not operational and a command is sent to the inverter, monitoring systems associated with SCADA 120 may detect error conditions which are in fact false negatives. To avoid this condition when the inverter is not operational, interrupt module 312 interrupts command flow and does not permit values for active power setpoint 340 to be provided from minimum selector module 310 to be sent to the inverter.

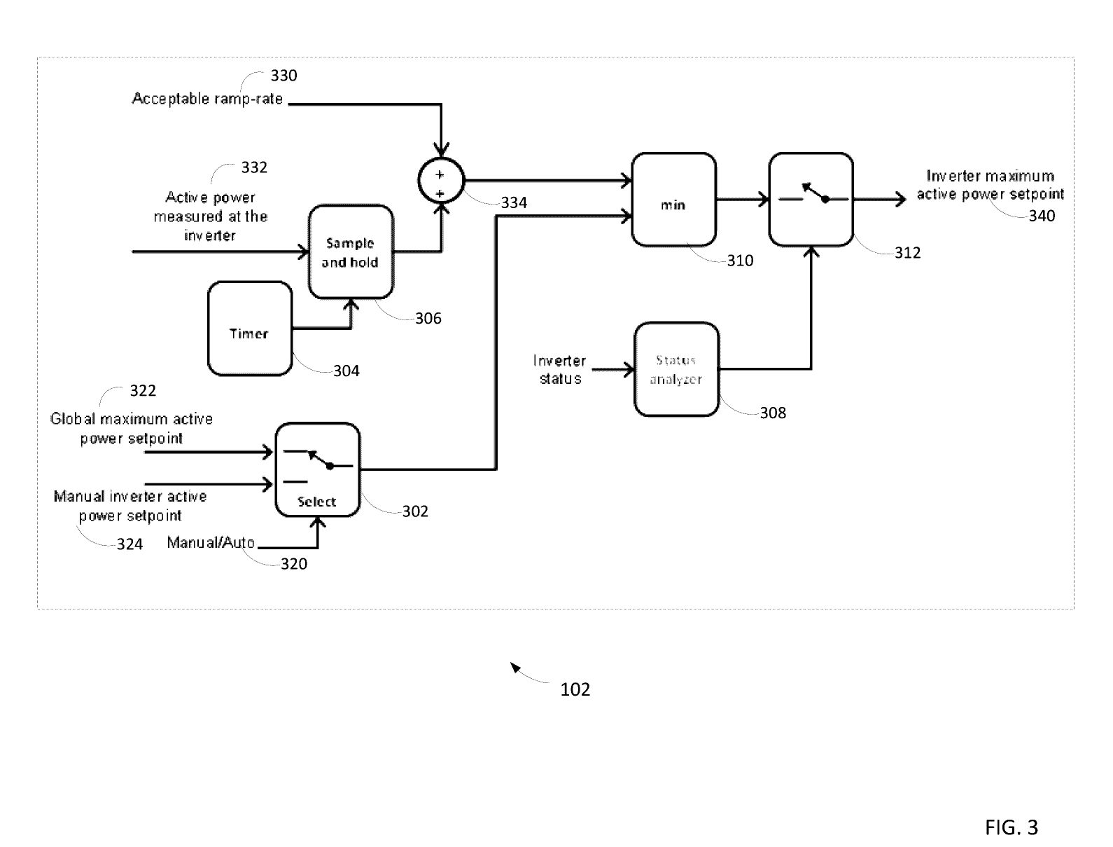

FIGS. 4 and 5 illustrate an example load following command flow used by DPC 102 to control the operation of individual PV inverters. In one embodiment, the load following command flow is initiated during times of load following power generation (e.g., to supplement base load or peaking power plants at times of high demand). A dynamic maximum power threshold (DMPT) module 404 receives a plurality of inputs, including active power generated by each inverter and operational system capacity metrics input by an operator operating SCADA 120. A differential of minimum net-load value and a net load (active power) measured at the POI is calculated and also input to the DMPT module 404. Furthermore, inverter active power setpoint 340 is also input into the DMPT module 404.

When the solar resource is limited (e.g., due to weather or other conditions), inverter active power setpoint 340 provided to the inverted may be much higher than the power generated by the inverter. In other words, the inverter may be unable to generate power equivalent to inverter active power setpoint 340. Moreover, when the solar resource is available again (e.g., when clouds pass), the inverter output may increase in an uncontrolled manner. DMPT module 404 is configured to detect such a condition by comparing inverter active power set-point 340 with power generated by the inverter and take corrective actions (explained further with respect to FIG. 5).

In one embodiment, DMPT module 404 is configured to limit a difference between inverter active power set-point 340 and power generated by the inverter. For example, DMPT module 404 may continuously calculate a numerical difference between inverter active power set-point 340 and power generated by the inverter and compare it to a predefined threshold or ceiling value. When the difference exceeds the ceiling (i.e., the setpoint is much too high compared to the inverter's generated power) DMPT module 404 may reduce inverter active power set-point 340 or take other actions to adjust the power generated by the inverter.

DMPT module 404 outputs to a positive deadband function 406 and a negative deadband function 408. From positive deadband function 406, the voltage value is fed to positive gain module 410. From negative deadband function 408, the voltage value is fed to a negative gain module 412. Voltage values from a positive gain module 410 and negative gain module 412 are summed 414 and fed to a limited proportional controller 216 and a limited integral controller 418. Limited proportional controller 416 determines a proportional gain Kₚ. Limited integral controller 420 determines an integral gain Kᵢ, and performs a Laplace transform of the integral gain Kᵢ. In one embodiment, a reset command 418 may also be applied at limited integral controller 224. The output voltage value from limited proportional controller 416 and limited integral controller 420 is summed 422 to create a global active power setpoint. An inverter status analyzer 424 receives status data from the inverter. Selector module 426 selects a voltage value and designates it the inverter active power setpoint 440. Inverter active power setpoint 440 is provided as input to the inverter.

As shown in FIG. 5, an operator inputs active power generated by each inverter and operational system capacity metrics into a divisor 504. In one embodiment, the active power generated by the inverter is measured in kilowatts (kW) while SCADA 120 is configured to measure power based on per unit value. Dividing active power generated by inverter into operational system capacity gives the per-unit value for the active power generated. The generated quotient is summed at a summer 506 with a maximum power threshold value input by the operator. A differential is taken 508 of the sum at summer 506 and inverter active power setpoint 440.

The differential at 508 is input into a sign module 510. Sign module 510 is configured to return a positive integer value for any input value larger than zero. In one embodiment, sign module 510 always returns a value of 1 for any input larger than zero, and returns a value of 0 for any input smaller than zero. A differential is taken 502 of a minimum net load (load-PV) command and a net load (active power) measured at the POI. The differential is input into a multiplier 512 with output from module 510 to generate an output directed to limited proportional controller 416 by way of positive deadband function 406 and negative deadband function 408.

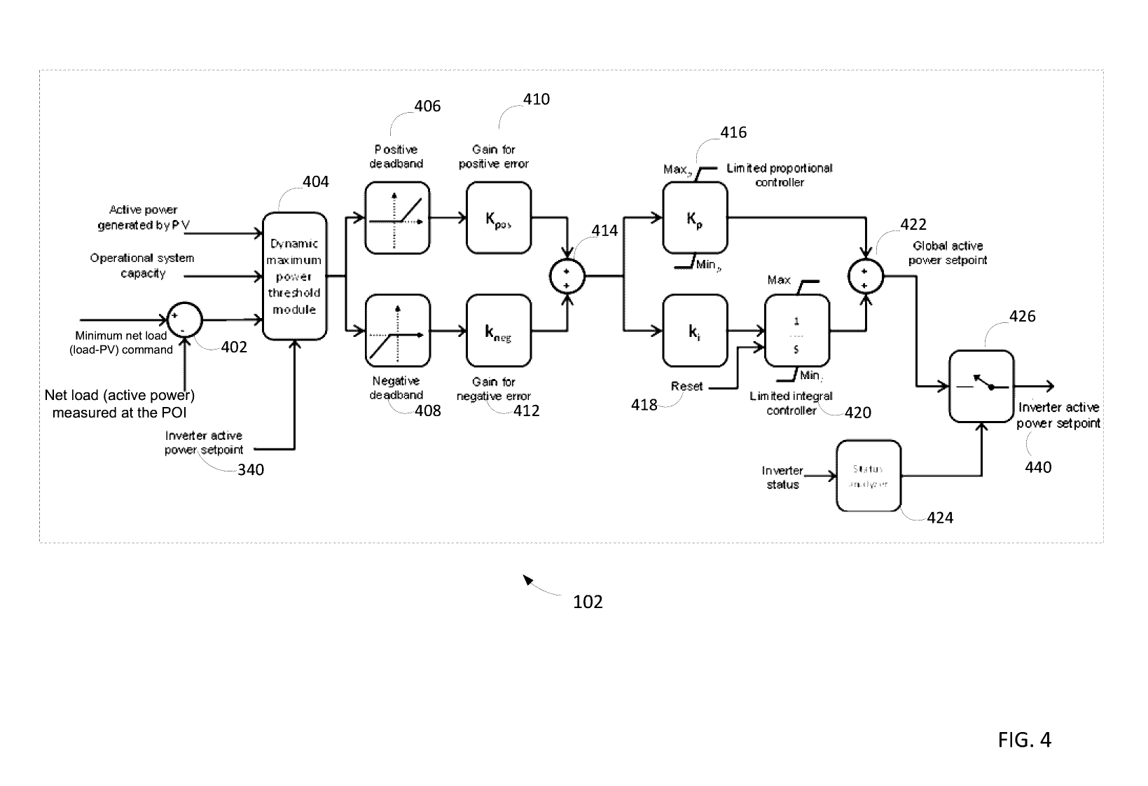

FIG. 6 illustrates an example reactive power command flow used by DPC 102 to control power factor in the operation of individual PV inverters. A power factor command from SCADA 120 is input into a first signum function 602 and a power factor measured at the POI is input into a second signum function 604. A differential is taken 606 of the outputs from first signum function 602 and second signum function 604. The differential is input into a deadband module 608. Deadband module 608 calculates a deadband value for the power factor differential and transmits the output to a limited proportional controller 612 and a limited integral controller 614. Limited proportional controller 612 determines a proportional gain Kₚ. Limited integral controller 614 determines an integral gain Kᵢ, and performs a Laplace transform of the integral gain Kᵢ. In one embodiment, a reset command 610 may also be applied at limited integral controller 614. The output voltage value from limited proportional controller 612 and limited integral controller 614 is summed at a summer 616. The sum at summer 616 is input into a third signum function 618 to generate a global power factor setpoint for power factor for the inverter.

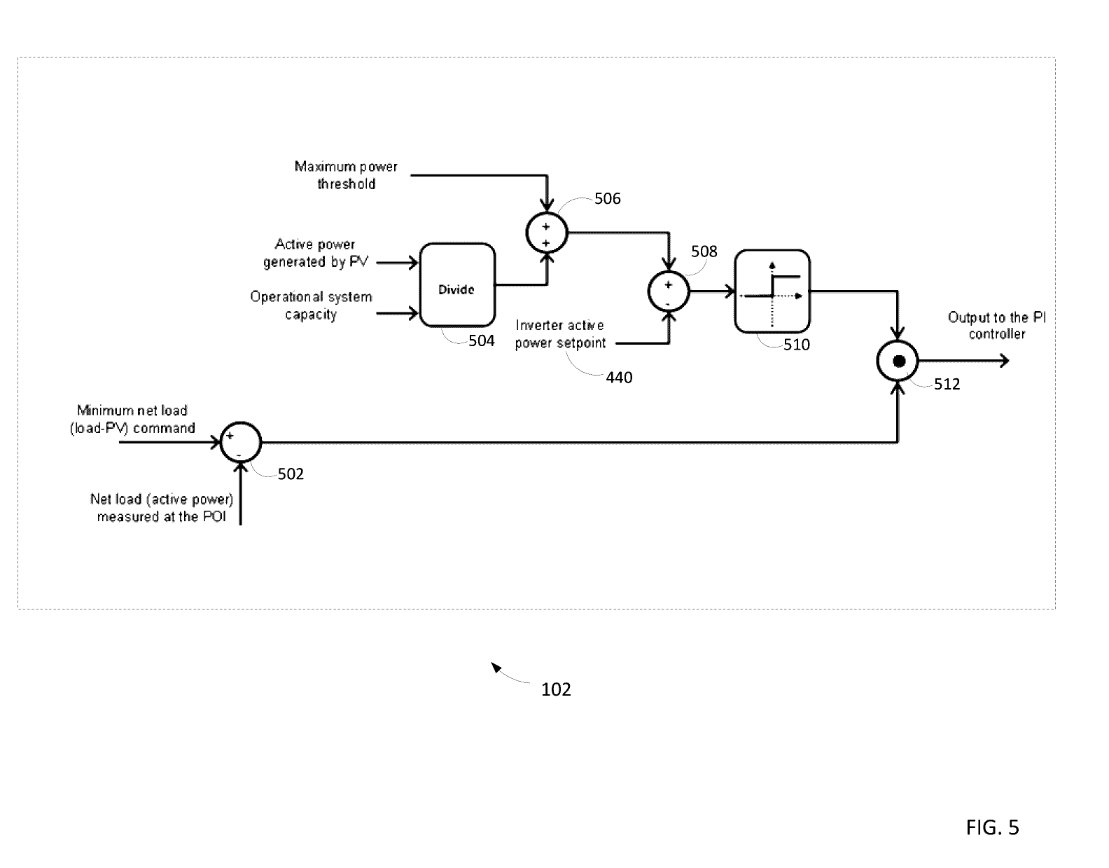

FIG. 7 illustrates an example reactive power command flow used by DPC 102 to control voltage in the operation of individual PV inverters. A voltage droop command is received from SCADA 120. A voltage differential is taken of a voltage command from SCADA 120 and a voltage measured at the POI, and the differential is input into a deadband module 704. Deadband module 704 calculates a deadband value for the voltage differential and transmits the output to a limited proportional controller 706. Limited proportional controller 706 determines a proportional gain Kₚ. The output voltage value from limited proportional controller 706 is input into a signum function 708 to generate a global power factor setpoint for voltage for the inverter.

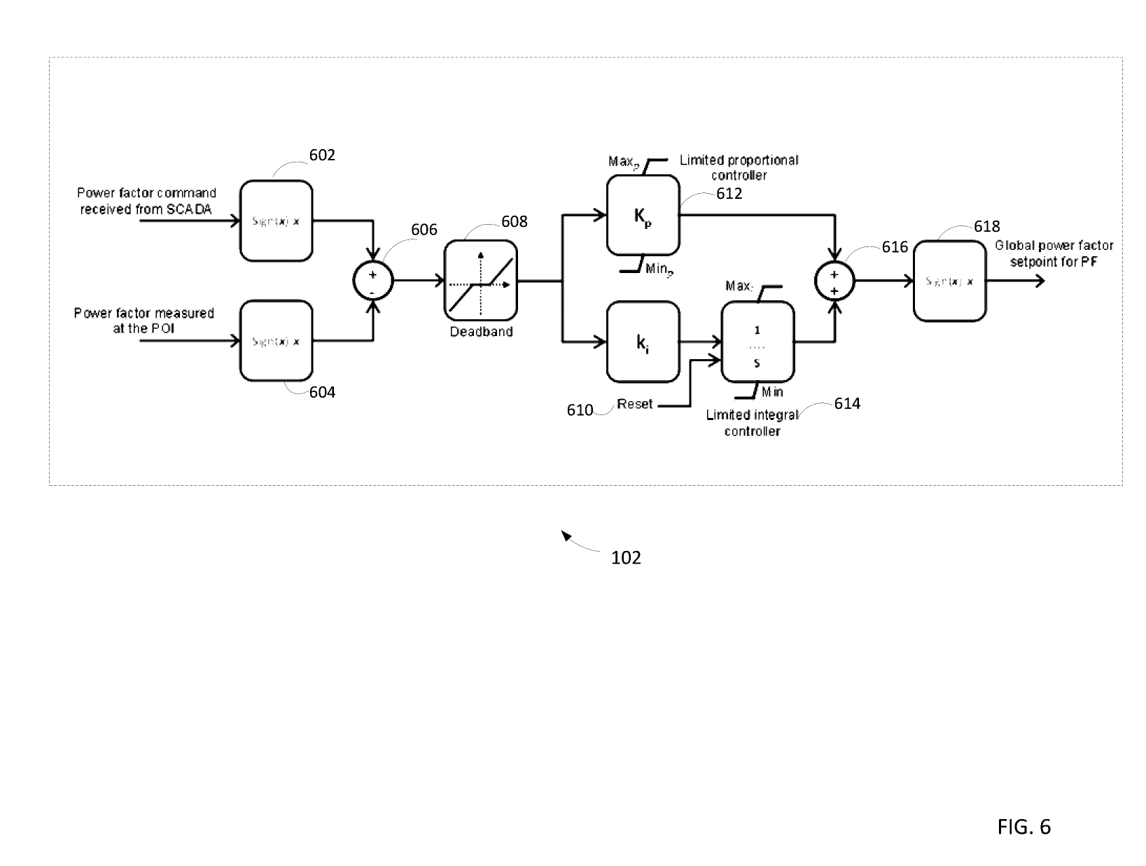

FIG. 8 illustrates an example reactive power command flow used by DPC 102 to control reactive power levels in the operation of individual PV inverters. A reactive power differential is taken 802 of a reactive power command from SCADA 120 and a reactive power measured at the POI, and the differential is input into a deadband module 804. Deadband module 804 calculates a deadband value for the power factor differential and transmits the output to a limited proportional controller 806 and a limited integral controller 808. Limited proportional controller 806 determines a proportional gain Kₚ. Limited integral controller 808 determines an integral gain Kᵢ, and performs a Laplace transform of the integral gain Kᵢ. In one embodiment, a reset command 810 may also be applied at limited integral controller 808. The output reactive power value from limited proportional controller 806 and limited integral controller 808 is summed at a summer 812. The sum at summer 812 is input into a signum function 814 to generate a global power factor setpoint for reactive power for the inverter.

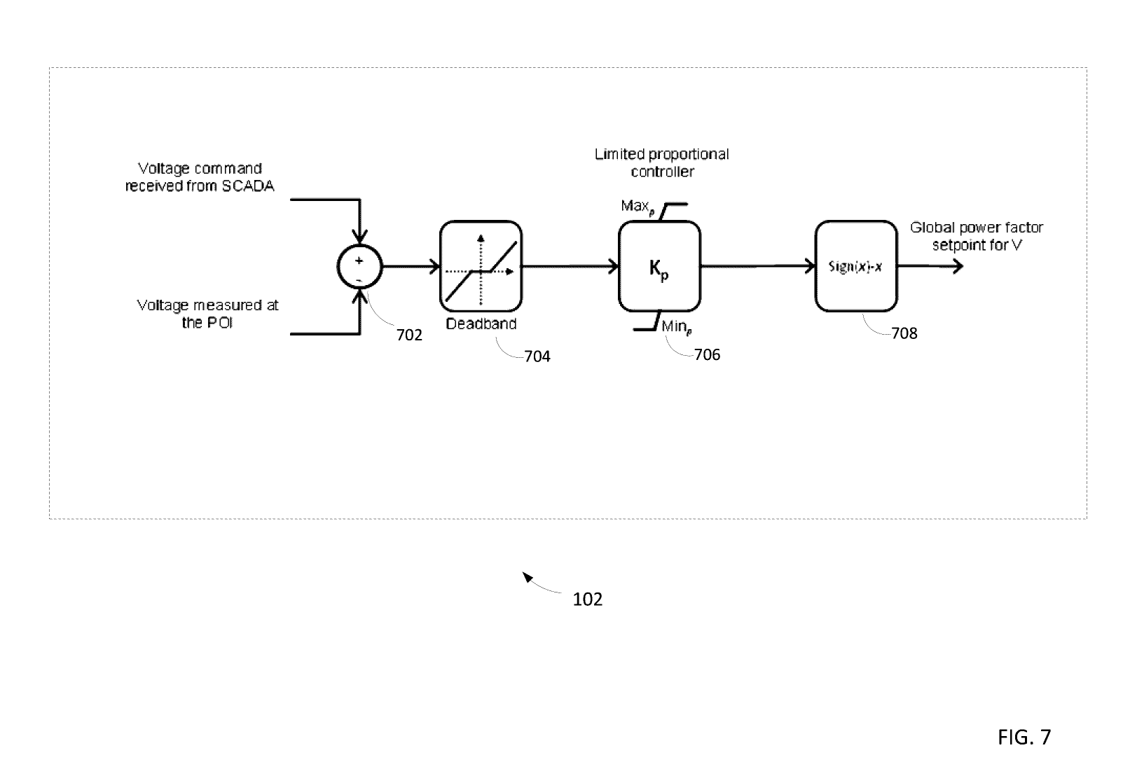

FIG. 9 illustrates an example flow showing the DPC 102 calculating an inverter power factor setpoint. A selector module 902 takes, as input, the global power factor setpoints for power factor, voltage, and reactive power, along with a manually entered power factor setpoint. When the selector module 902 is in reactive power control mode, it selects one of the power factor set points based on inputs received from SCADA 120, entered by an operator. Selector module 902 inputs the selection into a power factor rate controller module 904. In one embodiment, power factor rate controller module 904 receives input from selector module 902 as well as an acceptable power factor rate of change from SCADA 102 and a power factor measured at the inverter. Power factor rate controller module 904 is configured to generate a power factor rate of change (e.g., 2%/second) based on the received inputs.

A power optimizer 906 receives power factor rate of change from power factor rate controller module 904, as well as active power measured at the inverter, apparent capacity of the inverter, and a priority command for active vs. reactive power. The priority command, received from SCADA 120, informs power optimizer 906 as to whether active power control or reactive power control is currently a priority. Power optimizer 906 is configured to distribute reactive power among inverters such that inverters with more available free capacity can contribute more reactive power. Additionally, a status analyzer 908 receives status from each individual inverter and provides it to a module 910.

Similar interrupt module 312, interrupt module 910 is configured to interrupt command flow to the inverter based on status data received from status analyzer 908. For example, if status data indicates that the inverter is not operational and a command is sent to the inverter, monitoring systems associated with SCADA 120 may detect error conditions which are in fact false negatives. To avoid this condition when the inverter is not operational, interrupt module 910 interrupts command flow and does not permit values for active power setpoint to be provided from power optimizer 906 to be sent to the inverter.

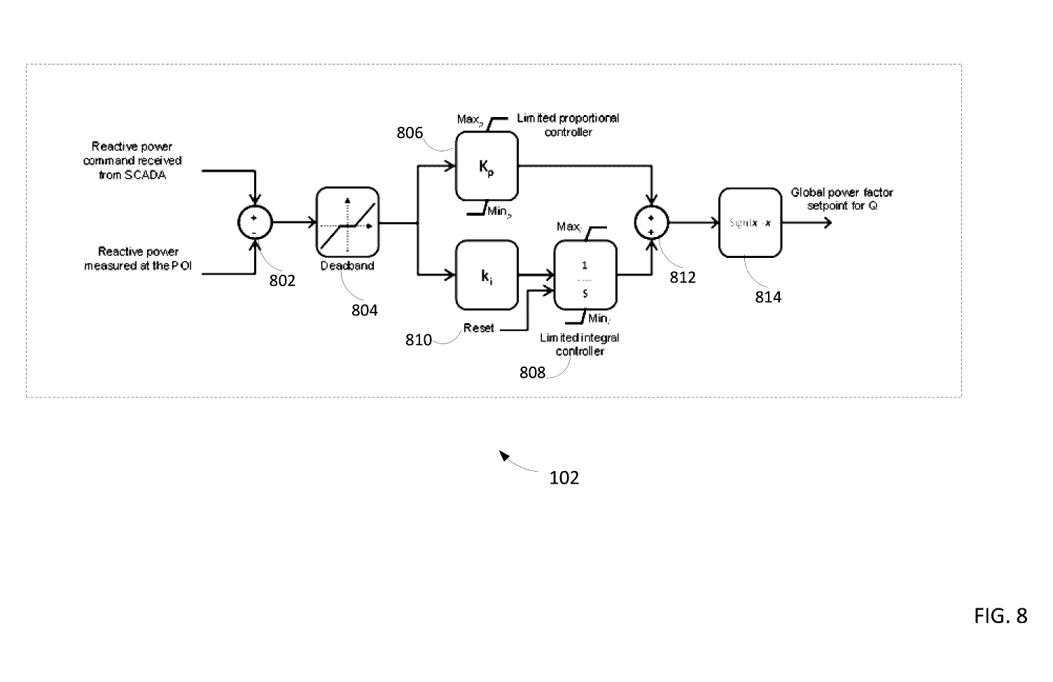

FIG. 10 illustrates an example method by which DPC 102 controls the operation of individual inverters. As shown, the DPC computer device is configured to receive 1002, from an electrical meter, at least one electrical value (e.g., voltage, power factor, current, or the like) associated with at least one inverter. The electrical meter is associated with at least one point of interconnection between the inverter and an electrical grid. The DPC computer device is configured to calculate 1004 an electrical metric (e.g., a global maximum active power setpoint or inverter maximum power setpoint) based on the at least one electrical value.

The DPC computer device is configured to generate 1006 a command signal for the inverter based on the calculated electrical metric. The DPC computer device is configured to transmit 1008 the command signal to the at least one inverter (e.g., via a computer network connection). The command signal is configured to adjust an output (e.g., power level, voltage, power factor, etc.) of the at least one inverter. Using the command signal, the DPC computer device is configured to command 1010 the inverter to update at least one output power level for the electrical value (e.g., increase power, decrease power, limit power to setpoint, limit power to within range, etc.).

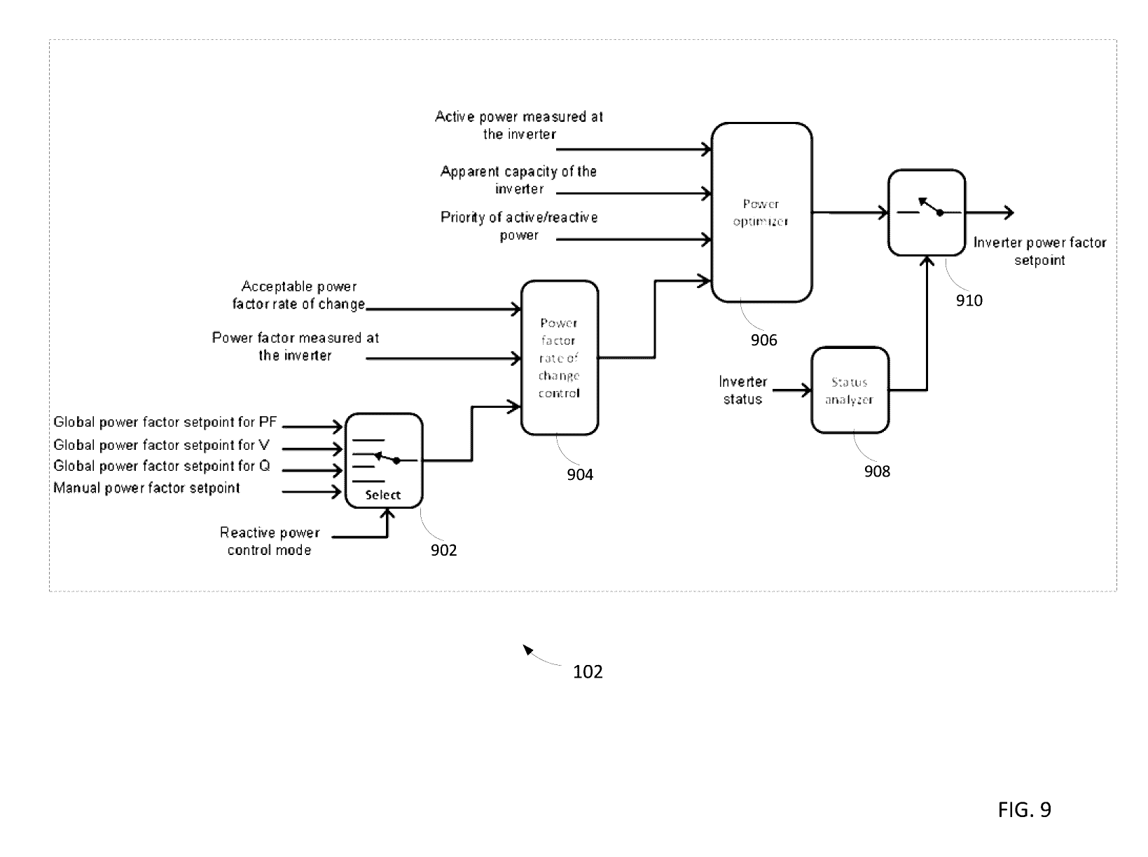

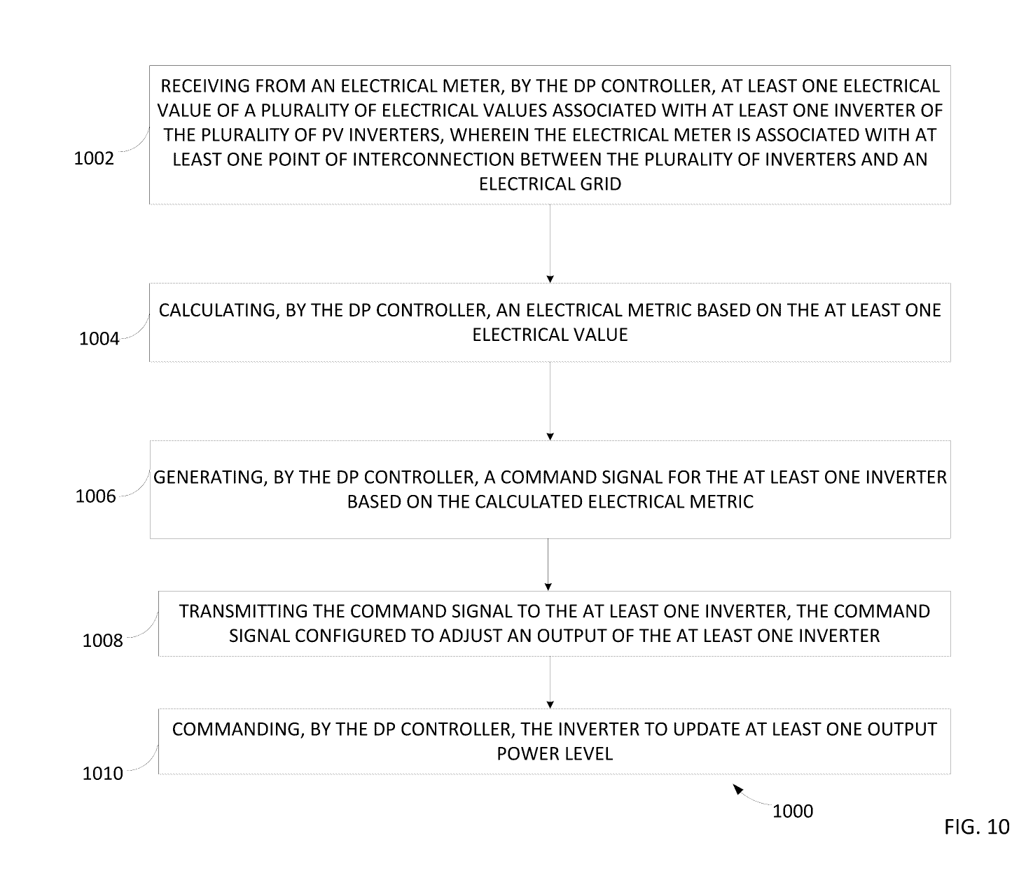

FIG. 11a shows an example graph of DPC 102 limiting active power in accordance with inputs received from the PV power plant system shown in FIG. 1. As shown, a hashed line represents an available level of active power output (pu) 1102 for an inverter. A solid line represents a generated level of active power output (pu) 1104 for the inverter. Active power output is represented herein as a proportion of the inverter's maximum capacity, with 0 on the vertical axis representing zero active power output and 1 representing a maximum active power output for the inverter. As shown in FIG. 11a, active power output 1102 approaches 1 (i.e., the maximum) at minute marker 6 and minute marker 9. However, DPC computer device has determined an active power limit of 80%. In other words, the inverter may not produce more than 80% of its available power capacity. In this way, the DPC computer device is able to command inverters not just to adhere to a particular setpoint, but also to limit their output using predetermined ceiling levels for power.

FIG. 11b shows an example graph of the DPC 102 limiting ramp rate in accordance with inputs received from the PV power plant system shown in FIG. 1. As shown, a hashed line represents an available level of active power output (pu) 1106 for an inverter. A solid line represents a generated level of active power output (pu) 1108 for the inverter. As shown in FIG. 11b, available power spikes to a maximum of 1 at minute marker 6 and minute marker 9. However, DPC computer device has determined a ramp rate limit of 30% per minute. So even though available power may rise to 1 between minute marker 8 and minute marker 9, the DPC computer device allows power to ramp up by only 30% within this interval, not to the maximum.

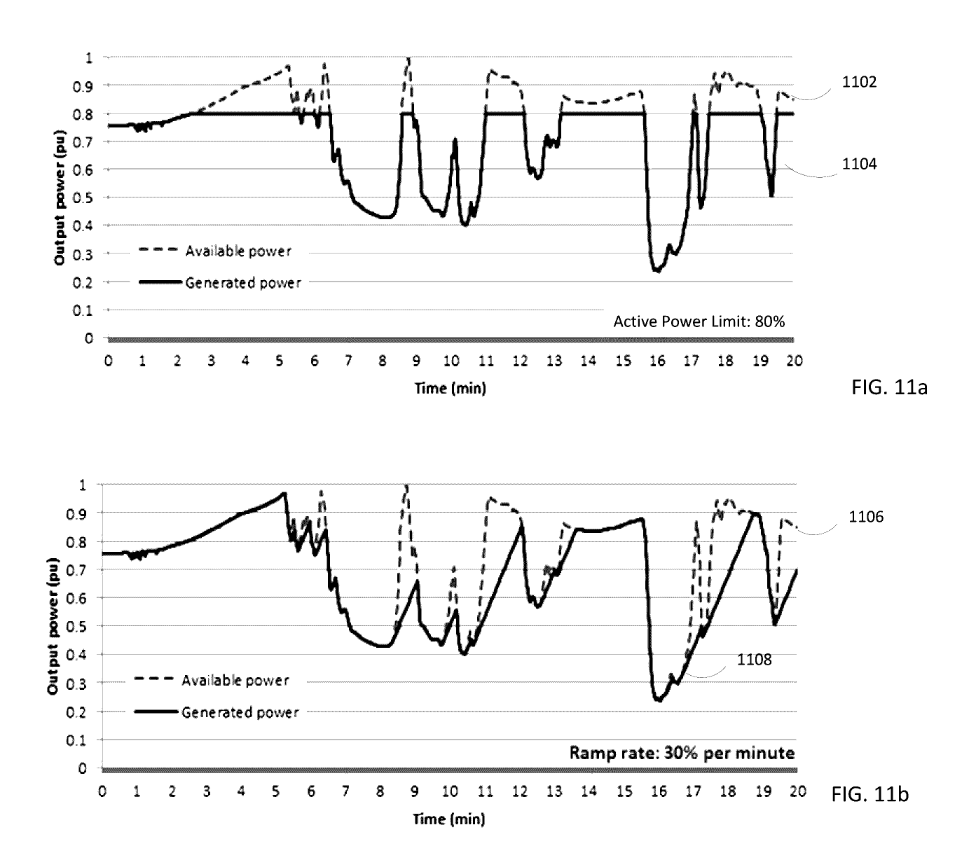

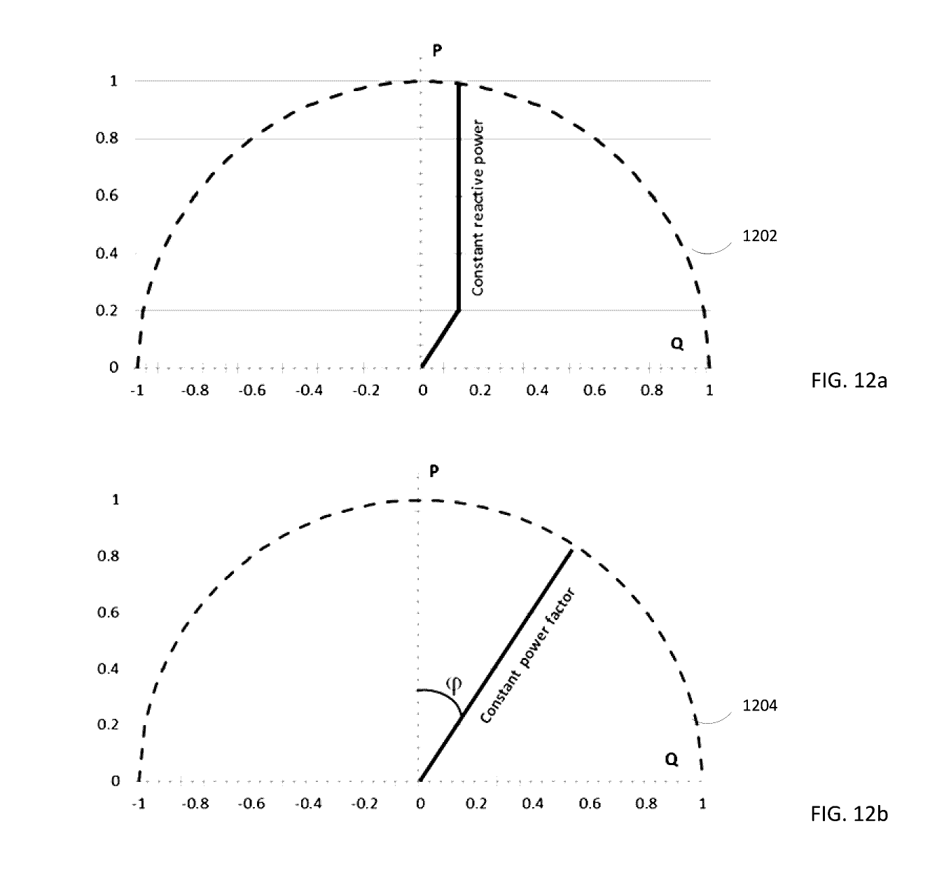

FIG. 12a is an example reactive power graph showing DPC 102 maintaining a constant reactive power level with respect to active power levels. A hashed line 1202 is shown, which represents that as active power P rises, reactive power Q falls, and vice versa. For example, as P approaches 1, Q approaches zero, in absolute terms. The DPC computer device adjusts the reactive power generated/consumed by the inverters to maintain a specific reactive power at the POI. In this way, the DPC computer device compensates for reactive power loss associated with power transformers, cables and auxiliary instruments, or the like.

FIG. 12b is an example power factor graph showing DPC 102 maintaining a constant power factor for each inverter. Power factor is defined as the ratio of active power to apparent power. A hashed line 1204 represents that as active power P rises, reactive power Q falls, and vice versa. However, the DPC computer device maintains a constant power factor φ (phi) for each inverter.

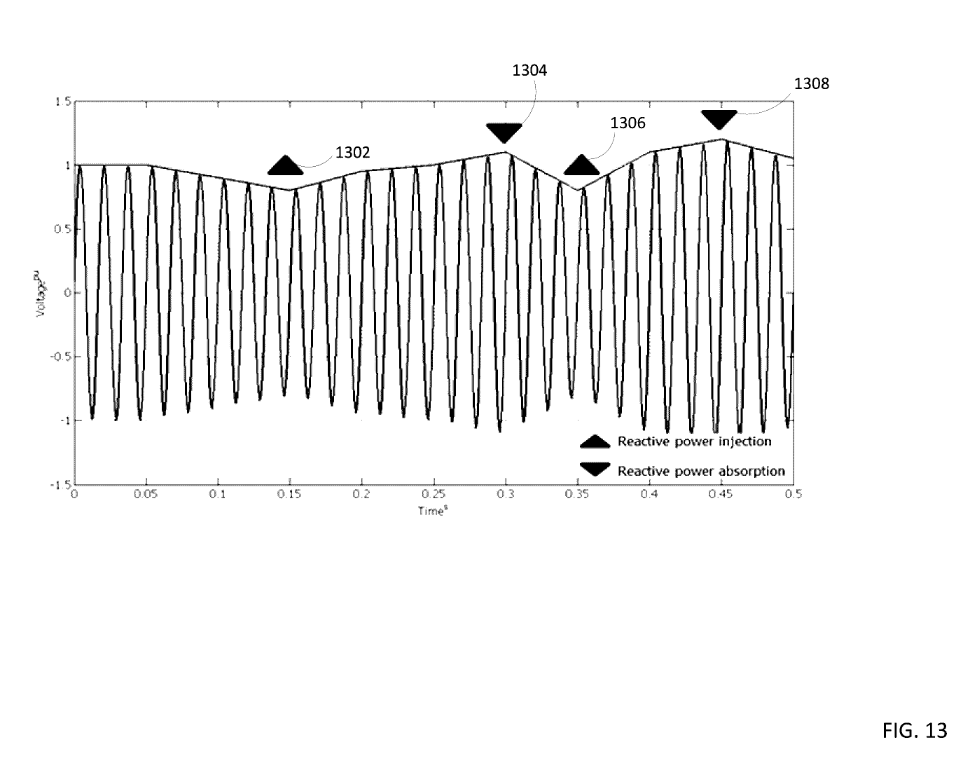

FIG. 13 is an example voltage graph showing DPC 102 providing inputs to an inverter to adjust reactive power. At 1302, the DPC computer device commands the inverter to increase reactive power, via a reactive power injection command. As shown in FIG. 13, voltage gradually rises after a point 1302. At a point 1304, the DPC computer device commands the inverter to decrease reactive power, via a reactive power absorption command. As shown in FIG. 13, voltage gradually falls after point 1304. Similarly, at a point 1306, the DPC computer device commands the inverter to increase reactive power, via a reactive power injection command. As shown in FIG. 13, voltage gradually rises after point 1306. At a point 1308, the DPC computer device commands the inverter to decrease reactive power, via a reactive power absorption command. As shown in FIG. 13, voltage gradually falls after point 1308. In this way, the DPC computer device adjusts the reactive power generated/consumed by the inverters to maintain a specific voltage at the POI and limits the adjustments to the power factor capability of the inverters.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

As will be appreciated based on the foregoing specification, the above-described embodiments of the disclosure may be implemented using computer programming or engineering techniques including computer software, firmware, hardware or any combination or subset thereof, wherein the technical effect is to control the operation of individual photovoltaic inverters. Any such resulting program, having computer-readable code means, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

What is claimed is:

1. A computer-implemented method for dynamically controlling a plurality of photovoltaic (PV) inverters, the method implemented by a dynamic photovoltaic (DP) controller in communication with a user interface, the method comprising:
receiving from an electrical meter, by the DP controller, at least one electrical value of a plurality of electrical values associated with at least one inverter of the plurality of PV inverters, wherein the electrical meter is associated with at least one point of interconnection between the plurality of inverters and an electrical grid;
calculating, by the DP controller, an electrical metric based on the at least one electrical value;
generating, by the DP controller, a command signal for the at least one inverter based on the calculated electrical metric;
transmitting the command signal to the at least one inverter, the command signal configured to change an output power level of the at least one inverter; and
causing the at least one inverter to change the power level via the command signal.

2. The method of claim 1, further comprising:
converting, by the DP controller, the command signal into a formatted command signal using a command signal format compatible with the inverter; and
transmitting the formatted command signal to the inverter.

3. The method of claim 1, further comprising:
generating a global maximum power set-point based on the plurality of electrical values received from the electrical meter;
determining the at least one output power level and at least one other output power level for least one other inverter of the plurality of PV inverters;
determining an inverter-specific active power set-point for the inverter, based on the global maximum power set-point, the at least one output power level, and the at least one other output power level; and
causing the inverter to update the at least one output power level.

4. The method of claim 3, wherein determining the inverter-specific active power set-point for the inverter further comprises:
determining a first power level delta value, wherein the first power level delta value represents a numerical difference between a total output power level for the plurality of PV inverters and the global maximum power set-point;
calculating a new value for the at least one output power level by adding the first power level delta value to the at least one power level; and
causing the inverter to update the at least one output power level to be equivalent to the new value.

5. The method of claim 1, further comprising:
receiving a maximum ramp rate via the user interface; and
causing the inverter to limit a rate of change in the at least one output power level to be less than or equal to the maximum ramp rate.

6. The method of claim 1, wherein the at least one electrical value includes a reactive power level for the inverter, further comprising:
determining a ratio of the reactive power level for the inverter to the at least one output power level;
comparing the ratio to an optimal power factor for the inverter; and
determining a second power level delta value, wherein the second power level delta value represents a difference between the at least one output power level and a desired output power level at which the ratio is equivalent to the optimal power factor; and
causing the inverter to update the at least one output power level based on the second power level delta value.

7. The method of claim 1, further comprising:
receiving a voltage droop factor from the user interface, wherein the voltage droop factor represents a percentage of an output voltage for the at least one point of interconnection;
generating a power factor command signal using the voltage droop factor; and
causing, in response to the power factor command signal, the inverter to update the at least one output power level based, at least in part, on the voltage droop factor.

8. The method of claim 1, further comprising:
calculating a fractional output power level representing the at least one output power level as a percentage of the total output power level;
determining that the fractional output power level exceeds a predefined threshold;
updating the inverter-specific active power set-point based on a numerical difference between the fractional output power level and the predefined threshold; and
causing the inverter to update the at least one output power level based on the updated inverter-specific active power set-point.

9. A dynamic PV power plant (DP) controller, the DP controller comprising a processor and a memory device, the DP controller being in communication with a supervisory control and data acquisition (SCADA) user interface, the DP controller configured to:
receive, from an electrical meter, at least one electrical value of a plurality of electrical values associated with at least one inverter of the plurality of PV inverters, wherein the electrical meter is associated with at least one point of interconnection between the plurality of inverters and an electrical grid;
calculate an electrical metric based on the at least one electrical value;
generate a command signal for the at least one inverter based on the calculated electrical metric;
transmit the command signal to the at least one inverter, the command signal configured to change an output power level of the at least one inverter; and
cause the at least one inverter to change the power level via the command signal.

10. The DP controller of claim 9, further configured to:
convert the command signal into formatted command signal using a command signal format compatible with the inverter; and
transmit the formatted command signal to the inverter.

11. The DP controller of claim 9, further configured to:
generate a global maximum power set-point based on the plurality of electrical values received from the electrical meter;
determine the at least one output power level and at least one other output power level for least one other inverter of the plurality of PV inverters;
determine an inverter-specific active power set-point for the inverter, based on the global maximum power set-point, the at least one output power level, and the at least one other output power level; and
cause the inverter to update the at least one output power level.

12. The DP controller of claim 9, wherein, to determine the inverter-specific active power set-point for the inverter the DP controller is further configured to:
determine a first power level delta value, wherein the first power level delta value represents a numerical difference between a total output power level for the plurality of PV inverters and the global maximum power set-point;
calculate a new value for the at least one output power level by adding the first power level delta value to the at least one power level; and
cause the inverter to update the at least one output power level to be equivalent to the new value.

13. The DP controller of claim 9, further configured to:
receive a maximum ramp rate via the user interface; and
cause the inverter to limit a rate of change in the at least one output power level to be less than or equal to the maximum ramp rate.

14. The DP controller of claim 9, wherein the at least one electrical value includes a reactive power level for the inverter, and wherein the DP controller is further configured to:
determine a ratio of the reactive power level for the inverter to the at least one output power level;
compare the ratio to an optimal power factor for the inverter;
determine a second power level delta value, wherein the second power level delta value represents a difference between the at least one output power level and a desired output power level at which the ratio is equivalent to the optimal power factor; and
cause the inverter to update the at least one output power level based on the second power level delta value.

15. The DP controller of claim 9, further configured to:
receive a voltage droop factor from the user interface, wherein the voltage droop factor represents a percentage of an output voltage for the at least one point of interconnection;
generate a power factor command signal using the voltage droop factor; and
cause, in response to the power factor command signal, the inverter to update the at least one output power level based, at least in part, on the voltage droop factor.

16. The DP controller of claim 9, further configured to:
calculating a fractional output power level representing the at least one output power level as a percentage of the total output power level;
determining that the fractional output power level exceeds a predefined threshold;
updating the inverter-specific active power set-point based on a numerical difference between the fractional output power level and the predefined threshold; and
commanding the inverter to update the at least one output power level based on the updated inverter-specific active power set-point.

17. One or more non-transitory computer-readable storage media having computer-executable instructions embodied thereon for dynamically controlling a plurality of photovoltaic (PV) inverters, wherein when executed by a dynamic photovoltaic power plant (DP) controller, said computer-executable instructions cause said DP controller to:
receive, from an electrical meter, at least one electrical value of a plurality of electrical values associated with at least one inverter of the plurality of PV inverters, wherein the electrical meter is associated with at least one point of interconnection between the plurality of inverters and an electrical grid;
calculate an electrical metric based on the at least one electrical value;
generate a command signal for the at least one inverter based on the calculated electrical metric;
transmit the command signal to the at least one inverter, the command signal configured to change an output power level of the at least one inverter; and
cause the at least one inverter to change the power level via the command signal.

18. The computer-readable storage media of claim 17, wherein the computer-executable instructions also cause the DP controller to:
convert the command signal into formatted command signal using a command signal format compatible with the inverter; and
transmit the formatted command signal to the inverter.

19. The computer-readable storage media of claim 17, wherein the computer-executable instructions also cause the DP controller to:
generate a global maximum power set-point based on the plurality of electrical values received from the electrical meter;
determine the at least one output power level and at least one other output power level for least one other inverter of the plurality of PV inverters;
determine an inverter-specific active power set-point for the inverter, based on the global maximum power set-point, the at least one output power level, and the at least one other output power level; and
cause the inverter to update the at least one output power level.

20. The computer-readable storage media of claim 17, wherein, to determine the inverter-specific active power set-point for the inverter, the computer-executable instructions also cause the DP controller to:
determine a first power level delta value, wherein the first power level delta value represents a numerical difference between a total output power level for the plurality of PV inverters and the global maximum power set-point;
calculate a new value for the at least one output power level by adding the first power level delta value to the at least one power level; and
cause the inverter to update the at least one output power level to be equivalent to the new value.

21. The computer-readable storage media of claim 17, wherein the computer-executable instructions also cause the DP controller to:
receive a maximum ramp rate via the user interface; and
cause the inverter to limit a rate of change in the at least one output power level to be less than or equal to the maximum ramp rate.

22. The computer-readable storage media of claim 17, wherein the at least one electrical value includes a reactive power level for the inverter, and wherein the computer-executable instructions also cause the DP controller to:
determine a ratio of the reactive power level for the inverter to the at least one output power level;
compare the ratio to an optimal power factor for the inverter;
determine a second power level delta value, wherein the second power level delta value represents a difference between the at least one output power level and a desired output power level at which the ratio is equivalent to the optimal power factor; and
cause, in response to the power factor command signal, the inverter to update the at least one output power level based, at least in part, on the voltage droop factor.

23. The computer-readable storage media of claim 17, wherein the computer-executable instructions also cause the DP controller to:
receive a voltage droop factor from the user interface, wherein the voltage droop factor represents a percentage of an output voltage for the at least one point of interconnection;
generate a power factor command signal using the voltage droop factor; and
cause, in response to the power factor command signal, the inverter to update the at least one output power level based, at least in part, on the voltage droop factor.

24. The computer-readable storage media of claim 17, wherein the computer-executable instructions also cause the DP controller to:
calculate a fractional output power level representing the at least one output power level as a percentage of the total output power level;
determine that the fractional output power level exceeds a predefined threshold;
update the inverter-specific active power set-point based on a numerical difference between the fractional output power level and the predefined threshold; and
cause the inverter to update the at least one output power level based on the updated inverter-specific active power set-point.
